(19) United States
(12) Patent Application Publication
(10) Pub. No.: US 2026/0031946 A1
(43) Pub. Date: Jan. 29, 2026

(54) METHOD FOR REPORTING INFORMATION, METHOD FOR TRANSMITTING INDICATION, DEVICE AND STORAGE MEDIUM

(71) Applicant: Beijing Xiaomi Mobile Software Co., Ltd., Beijing (CN)

(72) Inventors: Yumin WU, Beijing (CN); Deqian WANG, Beijing (CN); Shui LIU, Beijing (CN)

(73) Assignee: Beijing Xiaomi Mobile Software Co., Ltd., Beijing (CN)

(21) Appl. No.: 18/993,944

(22) PCT Filed: Jul. 14, 2022
(86) PCT No.: PCT/CN2022/105790

§ 371 Date: Jan. 13, 2025

(51) Int. Cl. H04L 5/00

(52) U.S. Cl. CPC H04L 5/0048; H04L 5/0094

(57) ABSTRACT

A method for reporting information, including: receiving indication information transmitted by a network device; and reporting expected related information for transmitting a sounding reference signal (SRS) to the network device, in response to determining that the network device allows the terminal to report the expected related information for transmitting the SRS according to the indication information.

### CROSS-REFERENCE

The present application is a U.S. National Stage of International Application No. PCT/CN2022/105790, filed on Jul. 14, 2022, the contents of all of which are incorporated herein by reference in their entireties for all purposes.

### BACKGROUND OF THE INVENTION

A terminal can transmit a sounding reference signal (SRS) to a network device. Related information for transmitting the SRS may be changed.

### SUMMARY OF THE INVENTION

The present disclosure relates to the technical field of communication, and in particular, to a method for reporting information, a method for transmitting an indication, a device for reporting information, a device for transmitting an indication, a communication device, and a computer-readable storage medium.

A method for reporting information, a method for transmitting an indication, a communication device, and a non-transitory computer-readable storage medium are provided in the embodiments of the present disclosure.

According to a first aspect of an embodiment of the present disclosure, a method for reporting the information is provided, which is performed by a terminal, includes: receiving indication information transmitted by a network device; and reporting expected related information for transmitting a sounding reference signal (SRS) to the network device, in response to determining that the network device allows the terminal to report the expected related information for transmitting the SRS according to the indication information.

According to a second aspect of an embodiment of the present disclosure, a method for transmitting an indication is provided, which is performed by a network device, includes: transmitting indication information to a terminal, where the indication information is configured to indicate whether the terminal is allowed to report expected related information for transmitting a sounding reference signal (SRS).

According to a third aspect of an embodiment of the present disclosure, a communication device is provided, which includes: a processor; and a memory that stores a computer program, where when the computer program, when executed by the processor, causes the processor to: receive indication information transmitted by a network device; and report expected related information for transmitting a sounding reference signal (SRS) to the network device, in response to determining that the network device allows the terminal to report the expected related information for transmitting the SRS according to the indication information.

According to a fourth aspect of an embodiment of the present disclosure, a communication device is provided, which includes: a processor; and a memory that stores a computer program, where the computer program, when executed by the processor, implements the aforementioned the method for transmitting the indication.

According to a fifth aspect of an embodiment of the present disclosure, a non-transitory computer-readable storage medium is provided, which storing a computer program, where the computer program, when executed by a processor, implements the aforementioned the method for reporting the information.

### BRIEF DESCRIPTION OF DRAWINGS

In order to more clearly illustrate the technical solutions in the embodiments of the present disclosure, the accompanying drawings which are required to be used in the description of the embodiments will be introduced briefly below. Apparently, the accompanying drawings described below are merely some embodiments of the present disclosure, and those of ordinary skill in the art can also obtain other accompanying drawings according to these accompanying drawings without making creative efforts.

FIG. 1 is a schematic flowchart of a method for reporting information according to an embodiment of the present disclosure.

FIG. 2 is a schematic flowchart of another method for reporting the information according to an embodiment of the present disclosure.

FIG. 3 is a schematic flowchart of yet another method for reporting the information according to an embodiment of the present disclosure.

FIG. 4 is a schematic flowchart of a method for transmitting an indication according to an embodiment of the present disclosure.

FIG. 5 is a schematic flowchart of another method for transmitting the indication according to an embodiment of the present disclosure.

FIG. 6 is a schematic flowchart of yet another method for transmitting the indication according to an embodiment of the present disclosure.

FIG. 7 is a schematic block diagram of a device for reporting the information according to an embodiment of the present disclosure.

FIG. 8 is a schematic block diagram of a device for transmitting the indication according to an embodiment of the present disclosure.

FIG. 9 is a schematic block diagram of a device for transmitting the indication according to an embodiment of the present disclosure.

FIG. 10 is a schematic block diagram of a device for reporting the information according to an embodiment of the present disclosure.

### DETAILED DESCRIPTION OF THE INVENTION

The technical solutions in the embodiments of the present disclosure will be clearly and completely described below with reference to the accompanying drawings in the embodiments of the present disclosure. Apparently, the described embodiments are only part of the embodiments of the present disclosure rather than all of them. Based on the embodiments of the present disclosure, all other embodiments obtained by those of ordinary skill in the art without creative efforts shall fall within the protection scope of the present disclosure.

The terms used in the embodiments of the present disclosure are merely intended for describing the specific embodiments rather than limiting the embodiments of the present disclosure. The singular forms, “a” and “this”, used in the embodiments and claims of the present disclosure are also intended to include plural forms, unless other meanings are clearly indicated in contexts. It will also be understood that the term “and/or” used herein refers to and includes any or all possible combinations of one or more associated listed items.

It will be understood that although terms like first, second and third may be adopted in the embodiments of the present disclosure to describe various information, the information is limited to such terms. Such terms are merely used to differentiate the same type of information from one another. For example, without departing from the scope of the embodiments of the present disclosure, the first information may also be called the second information, and likewise, the second information may also be called the first information. Depending on the context, the word “if” used herein may be interpreted as “when” or “in response to determining”.

For the purpose of conciseness and easy understanding, the terms used herein to represent the relationship between magnitudes are “greater than” or “less than” and “higher than” or “lower than”. However, for those skilled in the art, it can be understood that the term “greater than” also encompasses the meaning of “greater than or equal to” and “less than” also encompasses the meaning of “less than or equal to”; the term “higher than” encompasses the meaning of “higher than or equal to”, and “lower than” also encompasses the meaning of “lower than or equal to”.

In the related art, a terminal can transmit a sounding reference signal (SRS) to a network device. Related information for transmitting the SRS may be changed. For example, when a resource (e.g., a port for transmitting the SRS) for transmitting the SRS is occupied, the terminal has to use other resource to transmit the SRS. However, based on a current mechanism, the related information for transmitting the SRS cannot be changed in time. As a result, the terminal is unable to transmit the SRS by using an appropriate resource in time, thereby compromising the effectiveness and real-time performance of SRS transmission.

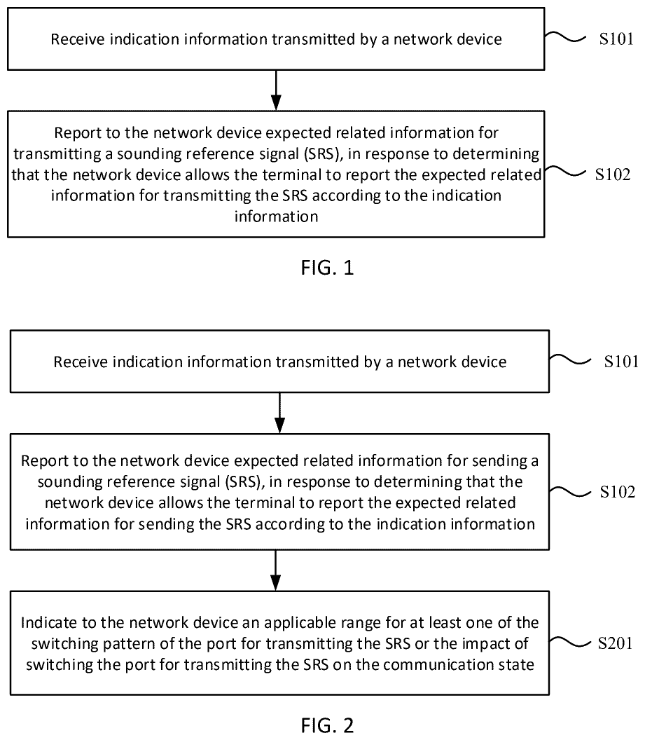

FIG. 1 is a schematic flowchart of a method for reporting information according to an embodiment of the present disclosure. The method for reporting the information illustrated in the present embodiment may be performed by a terminal, which includes, but is not limited to, a communication device such as a mobile phone, a tablet computer, a wearable device, a sensor or an Internet of Things device. The terminal may communicate with a network device, which includes, but is not limited to, a network device in 4G, 5G, 6G or other communication systems, such as a base station or a core network.

As shown in FIG. 1, the method for reporting the information may include the steps S101 and S102.

In step S101, indication information transmitted by a network device is received.

In step S102, expected related information for transmitting a sounding reference signal (SRS) is reported to the network device, in response to determining that the network device allows the terminal to report the expected related information for transmitting the SRS according to the indication information.

In one embodiment, the related information for transmitting the SRS, such as a time domain resource, a frequency domain resource and a port for transmitting the SRS, may be changed.

The network device may indicate the terminal to switch an SRS configuration through a radio resource control (RRC) signaling, or switch a bandwidth part (BWP) at the configured terminal, but these modes of indicating the terminal to switch the SRS configuration are not flexible enough to meet the requirements of the terminal.

For example, a plurality of subscriber identity module (SIM) cards may be arranged in the terminal, and the terminal may support Dual SIM Dual Active, Dual Receiving, Dual SIM Dual Standby, and other modes. Taking SIM card #1 and SIM card #2 among the plurality of SIM cards as an example, for example, when the terminal uses SIM card #1 for communication, the SRS is transmitted through port #1. In this process, SIM card #2 is started and occupies port #1, so the terminal cannot use port #1 to transmit the SRS successfully. In all the embodiments of the present disclosure, the port may refer to an antenna or a logical port.

In this case, the port for transmitting the SRS will be changed. For example, in order to continue to transmit the SRS, the terminal may switch from port #1 to port #2 to transmit the SRS. However, the terminal needs to wait for the RRC signaling or a BWP switching indication transmitted by the network device before adjusting the port for transmitting the SRS. On the one hand, the network device does not know that the port #1 has been occupied, so it is difficult to accurately indicate the terminal to switch to an unoccupied port to transmit the SRS. On the other hand, neither the RRC signaling nor the BWP switching indication can achieve dynamic indication. For example, the RRC signaling is generally transmitted during establishment or disconnection of RRC connection, so it is impossible to dynamically change a configuration for transmitting the SRS by the terminal at any time, based on indications of changes in different scenarios and SIM card pathways, compromising the effectiveness and real-time performance of SRS transmission.

It should be noted that the reasons for the terminal to switch the port for transmitting the SRS include, but are not limited to, the aforementioned impact of using the SIM cards. For example, the terminal itself needs to adjust a capability of switching a port for transmitting sounding reference signal srs-TxPortSwitch, which will also lead to a need for switching the port.

According to the embodiments of the present disclosure, on the one hand, the terminal can report the expected related information for transmitting the SRS to the network device, so that the network device can timely and accurately determine the expected related information for transmitting the SRS of the terminal. Thus, the expected related information for transmitting the SRS of the terminal can be dynamically transmitted to the terminal as configuration information, the terminal can successfully transmit the SRS, improving accuracy and timeliness of air interface environment evaluation. And the terminal can determine, according to indication information, whether the network device allows the terminal to report the expected related information for transmitting the SRS, and reports the expected related information for transmitting the SRS when allowed, and does not report the expected related information for transmitting the SRS when not allowed, which helps meet the control of the network device on uplink transmission.

For example, in the case where port #1 has been occupied by SIM card #2 in the aforementioned embodiment, the expected related information for transmitting the SRS of the terminal includes port #2, and in response to determining that the terminal is allowed to report the expected related information for transmitting the SRS, the expected port for transmitting the SRS includes port #2 may be reported. Accordingly, the network device can determine that the terminal expects to switch to port #2 to transmit the SRS, and then configuration information can be transmitted to the terminal, to configure the terminal to use port #2 to transmit the SRS. Accordingly, the terminal can switch to port #2 to transmit the SRS in time, thus ensuring that the SRS can be successfully transmitted.

It should be noted that the expected related information for transmitting the SRS transmitted to the network device by the terminal only determined as auxiliary information, which helps the network device to determine configuration information transmitted to the terminal but cannot determine a configuration transmitted to the terminal by the network device. That is, the network device may determine configuration information according to the expected related information for transmitting the SRS of the terminal, or may determine configuration information by itself only according to the actual condition of the network device without considering the expected related information for transmitting the SRS of the terminal.

In one embodiment, according to the expected related information for transmitting the SRS reported by the terminal, the network device may select one related information for transmitting the SRS from a plurality of related information for transmitting the SRS and indicate to the terminal the related information for transmitting the SRS. The plurality of related information for transmitting the SRS may be indicated to the terminal in advance by the network device (for example, configured to the terminal through the RRC signaling), or may be appointed by a protocol. The following embodiments mainly illustrate the case where the plurality of related information for transmitting the SRS are indicated to the terminal in advance by the network device.

In one embodiment, the configuration information transmitted to the terminal by the network device includes, but is not limited to, downlink control information (DCI), a media access control element (MAC CE), etc. Determining the DCI, the MAC CE and so on as the configuration information, the related information for transmitting the SRS may be dynamically adjusted, and the adjustment can be completed relatively in time compared with the adjustment of the related information for transmitting the SRS via the RRC signaling or the BWP switching indication.

In one embodiment, the expected related information for transmitting the SRS includes at least one of: a switching pattern of a port for transmitting the SRS; an impact of switching the port for transmitting the SRS on a communication state; a resource for transmitting the SRS; and a usage mode of the resource for transmitting the SRS.

In one embodiment, the switching pattern of the port for transmitting the SRS may refer to a quantity or a quantity combination of a receiving antenna (r) and a transmitting antenna (t) supported by the terminal, which may be determined by the terminal according to a current capability of srs-TxPortSwitch, so the expected switching pattern of the port for transmitting the SRS of the terminal may be represented as preferred-SupportedSRS-TxPortSwitch. For example, t1r2 represents that the terminal supports one transmitting antenna and two receiving antennas. For example, t2r4-t2r4 represents that the terminal supports one transmitting antenna and four receiving antennas, and also supports two transmitting antennas and four receiving antennas.

The quantity or the quantity combination of the receiving antenna (r) and the transmitting antenna (t) supported by the terminal include at least one of: t1r2, t1r4, t2r4, t2r2, t4r4, t1r4-t2r4, t1r1-t1r2, t1r1-t1r2-t1r4, t1r1-t1r2-t2r2-t2r4, t1r1-t2r2, t1r1-t2r2-t4r4, or t1r1-t1r2-t2r2-t1r4-t2r4.

It can be seen that the receiving antenna and the transmitting antenna supported by the terminal change with variations in the capability of the srs-TxPortSwitch of the terminal. Accordingly, after the capability of the srs-TxPortSwitch of the terminal has been changed, the switching pattern of the port for transmitting the SRS corresponding to the changed capability of the srs-TxPortSwitch may be reported to the network device. For example, if the unchanged capability of the srs-TxPortSwitch is t4r4 and the changed capability of the srs-TxPortSwitch is t2r2, then the expected switching pattern of the port for transmitting the SRS reported by the terminal may be t2r2. The network device may determine the port that the terminal can used for transmitting the SRS, according to the switching pattern of the port for transmitting the SRS, and then configure available ports for the terminal through the configuration information, so that the terminal can switch to the port in time to ensure successful transmitting of the SRS.

In one embodiment, the impact of switching the port for transmitting the SRS on the communication state includes at least one of: a downlink frequency affected by switching the port for transmitting the SRS, for example, it may be referred to txSwitchImpactToRx; an uplink frequency affected by switching the port for transmitting the SRS, for example, it may be referred to txSwitchWithAnotherBand; whether the downlink frequency is affected by switching the port for transmitting the SRS, for example, when the downlink frequency is affected by switching the port for transmitting the SRS, it may be referred to txSwitchImpactToRx, and when the downlink frequency is unaffected by switching the port for transmitting the SRS, it may be referred to txSwitchNoImpactToRx; and whether the uplink frequency is affected by switching the port for transmitting the SRS, for example, when the uplink frequency is affected by switching the port for transmitting the SRS, it is referred to txSwitch WithAnotherBand, and when the uplink frequency is unaffected by switching the port for transmitting the SRS, it is referred to txSwitchNoImpactWithAnotherBand.

When the terminal switches the port for transmitting the SRS, the communication state is affected or unaffected, and the impact on the communication state may be different based on the different capabilities of the srs-TxPortSwitch supported by the terminal.

For example, in a case where the terminal supports t4r4, the downlink frequency is affected by switching the port for transmitting the SRS, a band specifically affected is band-x, and then the expected txSwitchImpactToRx reported by the terminal may be band-x. Accordingly, the network device can determine that band-x is affected, and then a frequency domain resource other than band-x may be configured for the terminal to receive downlink information, to ensure that the terminal can successfully receive the downlink information. When the capability of the srs-TxPortSwitch of the terminal is changed to t2r2, if switching port for transmitting the SRS does not affect the downlink frequency, then the terminal may report txSwitchNoImpactToRx.

For example, in a case where the terminal supports t4r4, the uplink frequency is affected by switching the port for transmitting the SRS, a band specifically affected is band-y, and then the expected txSwitch WithAnotherBand reported by the terminal may be band-y. Accordingly, the network device can determine that band-y is affected, and then a frequency domain resource other than band-y may be configured for the terminal to transmit the SRS, to ensure that the terminal can successfully transmit the SRS. When the capability of the srs-TxPortSwitch of the terminal is changed to t2r2, if switching the port for transmitting the SRS does not affect the uplink frequency, then the terminal may report txSwitchNoImpactWithAnotherBand.

For example, in a case where the terminal supports t4r4, by switching the port for transmitting the SRS, the affected downlink frequency is band-x1 and the affected uplink frequency is band-x2, and then the expected txSwitchImpactToRx reported by the terminal may be band-x1 and the expected txSwitch WithAnotherBand reported by the terminal may be band-x2. Accordingly, the network device can determine that downlink reception of band-x1 and uplink transmission of band-x2 are affected, so a frequency domain resource other than band-x1 may be configured for the terminal to receive downlink information, and a frequency domain resource other than band-x2 may be configured for the terminal to transmit an uplink SRS.

When the capability of the srs-TxPortSwitch of the terminal is changed to t2r2, by switching the port for transmitting the SRS, the affected downlink frequency is changed to band-y1 and the affected uplink frequency is changed to band-y2, and then the expected txSwitchImpactToRx reported by the terminal may be band-y1 and the expected txSwitch WithAnotherBand reported by the terminal may be band-y2. Accordingly, the network device can determine that downlink reception of band-y1 and uplink transmission of band-y2 are affected, so a frequency domain resource other than band-y1 may be configured for the terminal to receive downlink information, and a frequency domain resource other than band-y2 may be configured for the terminal to transmit the uplink SRS.

In one embodiment, the resource for transmitting the SRS includes at least one of: a set SRS-ResourceSet of resources for transmitting the SRS; a resource SRS-Resource in the set; a port AntennaPortForSRS-ResourceSet corresponding to the set; a port AntennaPortForSRS corresponding to the resource; and a type SRS-ResourceType of the resource (the type includes, but not limited to, periodic, aperiodic, semi-persistent and etc.).

It should be noted that the related information for transmitting the SRS may include not only the resource for transmitting the SRS, but also a number of the resource for transmitting the SRS, such as a number of the set and a number of the port.

In one embodiment, the network device may configure a plurality of SRS-ResourceSets for the terminal in advance, and each SRS-ResourceSet may include at least one SRS-Resource (e.g., the time domain resource and/or the frequency domain resource). Then, when the terminal determines that the terminal is allowed to report an expected SRS-ResourceSet, the expected SRS-ResourceSet may be selected from the plurality of SRS-ResourceSets according to the terminal's own need and reported to the network device, the network device may transmit configuration information to the terminal according to the expected SRS-ResourceSet of the terminal, and the terminal may transmit the SRS according to the resource in the SRS-ResourceSet configured by the configuration information.

In one embodiment, the network device may configure a plurality of SRS-Resources in each SRS-ResourceSet for the terminal in advance. Then, when the terminal determines that the terminal is allowed to report an expected SRS-Resource, the expected SRS-Resource may be selected from the plurality of SRS-Resources according to the terminal's own need and reported to the network device, the network device may transmit configuration information to the terminal according to the expected SRS-Resource of the terminal, and the terminal may transmit the SRS according to the SRS-Resource configured by the configuration information.

In one embodiment, the network device may configure a plurality of AntennaPortForSRS-ResourceSets for the terminal in advance. Then, when the terminal determines that the terminal is allowed to report an expected AntennaPortForSRS-ResourceSet, the expected AntennaPortForSRS-ResourceSet may be selected from the plurality of AntennaPortForSRS-ResourceSets according to the terminal's own need and reported to the network device, the network device may transmit configuration information to the terminal according to the expected AntennaPortForSRS-ResourceSet of the terminal, and the terminal may transmit the SRS according to the AntennaPortForSRS-ResourceSet configured by the configuration information.

In one embodiment, the network device may configure a plurality of AntennaPortForSRSs for the terminal in advance. Then, when the terminal determines that the terminal is allowed to report an expected AntennaPortForSRS, the expected AntennaPortForSRS may be selected from the plurality of AntennaPortForSRSs according to the terminal's own need and reported to the network device, the network device may transmit configuration information to the terminal according to the expected AntennaPortForSRS of the terminal, and the terminal may transmit the SRS according to the AntennaPortForSRS configured by the configuration information.

In one embodiment, the usage mode of the resource for transmitting the SRS includes at least one of: antenna switching; beam management; codebook; or non-codebook.

In one embodiment, when the terminal determines that the terminal is allowed to report an expected usage mode of the resource for transmitting the SRS, the expected usage mode may be selected from the aforementioned usage modes according to the terminal's own need and reported to the network device, the network device may transmit configuration information to the terminal according to the expected usage mode of the terminal, and the terminal may transmit the SRS according to the usage mode configured by the configuration information.

FIG. 2 is a schematic flowchart of another method for reporting the information according to an embodiment of the present disclosure. As shown in FIG. 2, the method further includes step S201.

In step S201, an applicable range for at least one of the switching pattern of the port for transmitting the SRS or the impact of switching the port for transmitting the SRS on the communication state is indicated to the network device.

The applicable range includes at least one of: a radio access technology (RAT), including, but not limited to, 4G, 5G, 6G, etc.; a band; a bandwidth part (BWP); a cell; and the terminal, e.g., user equipment (UE).

In one embodiment, in a case where the terminal reports the expected switching pattern of the port for transmitting the SRS to the network device, the terminal can also indicate to the network device the applicable range for the switching pattern of the port for transmitting the SRS. Similarly, in a case where the terminal reports the expected impact of switching the port for transmitting the SRS on the communication state to the network device, the terminal can also indicate to the network device the applicable range of the impact of switching the port for transmitting the SRS on the communication state.

Taking the terminal reporting the expected switching pattern of the port for transmitting the SRS to the network device as an example, if the indicated applicable range is the terminal (e.g., per UE), then the network device may transmit configuration information to the indicated terminal according to the expected switching pattern of the port for transmitting the SRS; if the indicated applicable range is the cell (e.g., per Cell), then the network device may transmit configuration information to the terminal in the indicated cell according to the expected switching pattern of the port for transmitting the SRS; if the indicated applicable range is the bandwidth part (e.g., per BWP), then the network device may transmit configuration information to the terminal using the indicated bandwidth part according to the expected switching pattern of the port for transmitting the SRS; if the indicated applicable range is the band (e.g., per band), then the network device may transmit configuration information to the terminal using the indicated band according to the expected switching pattern of the port for transmitting the SRS; and if the indicated applicable range is the wireless access technology (e.g., per RAT), then the network device may transmit configuration information to the terminal using the indicated wireless access technology according to the expected switching pattern of the port for transmitting the SRS.

The band in the applicable range may be a single band, a band combination (e.g., per Band Combination), or a single band in the band combination (e.g., per Band per Band Combination).

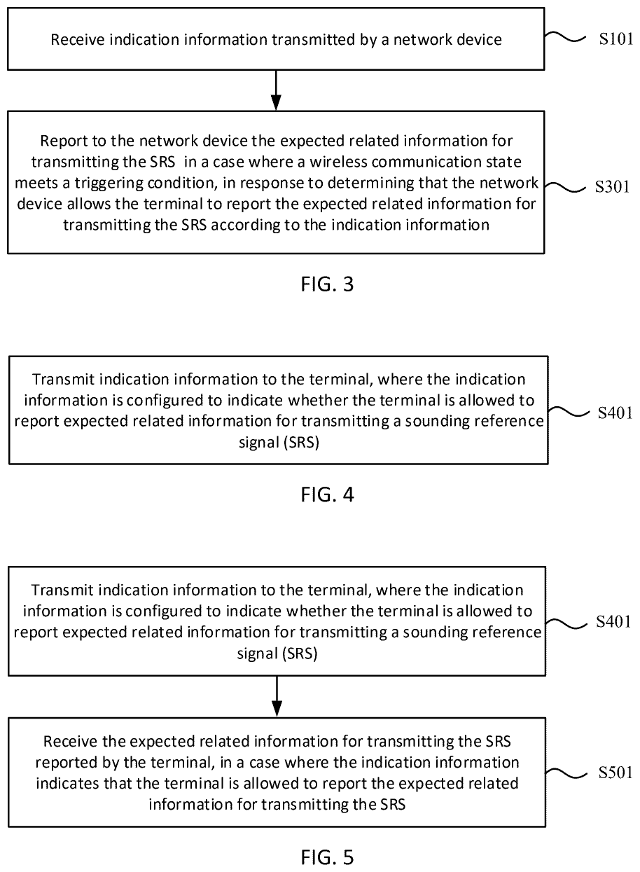

FIG. 3 is a schematic flowchart of yet another method for reporting the information according to an embodiment of the present disclosure. As shown in FIG. 3, reporting the expected related information for transmitting the SRS to the network device includes step S101 and S103.

In step S301, the expected related information for transmitting the SRS is reported to the network device, in a case where a wireless communication state meets a triggering condition.

In one embodiment, meeting the triggering condition includes at least one of: an antenna of the terminal is occupied; and the expected related information for transmitting the SRS of the terminal is changed.

The triggering condition may be appointed by a protocol, configured by the network device, or determined by the terminal itself.

The antenna of the terminal is occupied may include a type of the occupied antenna, an occupier of the antenna, etc. For example, the type includes a receiving antenna and a transmitting antenna, and the occupier includes a specific SIM card, a specific RAT (e.g., WiFi or Bluetooth), and a specific function (e.g., receiving or transmitting of a positioning signal).

After determining that the terminal is allowed by the network device to report the expected related information for transmitting the SRS of the terminal, the terminal may judge whether the wireless communication state meets the triggering condition, where the triggering condition may be a factor which causes the expected related information for transmitting the SRS to change. For example, the antenna of the terminal is occupied (then the port for transmitting the SRS will be limited, which may cause the expected related information for transmitting to SRS to change), or the terminal changes the expected related information for transmitting the SRS for its own needs).

Because uplink resources need to be occupied in order to report the expected related information for transmitting the SRS to the network device, if it is determined that the triggering condition is not met, it means that the expected related information for transmitting the SRS of the terminal is not changed, then the terminal may continue to transmit the SRS according to the configuration information previously transmitted by the network device, without needing to report the expected related information for transmitting the SRS, which helps save the uplink resource. When it is determined that the triggering condition is met, it means that the expected related information for transmitting the SRS is changed, and the terminal needs to report the expected related information for transmitting the SRS to the network device, so that the network device can re-determine configuration information and transmit the configuration information to the terminal.

FIG. 4 is a schematic flowchart of a method for transmitting an indication according to an embodiment of the present disclosure. The method for transmitting an indication illustrated in the present embodiment may be performed by the network device, which may communicate with the terminal. The network device includes, but is not limited to, a base station in a communication system, such as a 4G base station, a 5G base station or a 6G base station, and the terminal includes, but is not limited to, a communication device, such as a mobile phone, a tablet computer, a wearable device, a sensor or an Internet of Things device.

As shown in FIG. 4, the method for transmitting an indication may include the following steps S401.

In step S401, indication information is transmitted to the terminal, where the indication information is configured to indicate whether the terminal is allowed to report expected related information for transmitting a sounding reference signal (SRS).

In one embodiment, the related information for transmitting the SRS, such as the time domain resource, the frequency domain resource and the port for transmitting the SRS, may be changed.

The network device may indicate the terminal to switch the SRS configuration through the radio resource control (RRC) signaling, or switch the bandwidth part (BWP) at the configured terminal, but these modes of indicating the terminal to switch the SRS configuration are not flexible enough to meet the requirements of the terminal.

For example, a plurality of SIM cards may be arranged in the terminal, and the terminal may support Dual SIM Dual Active, Dual Receiving, Dual SIM Dual Standby, and other modes. Taking SIM card #1 and SIM card #2 among the plurality of SIM cards as an example, for example, when the terminal uses SIM card #1 for communication, the SRS is transmitted through port #1. In this process, SIM card #2 is started and occupies port #1, so the terminal cannot use port #1 to transmit the SRS successfully. In all the embodiments of the present disclosure, the port may refer to an antenna or a logical port.

In this case, the port for transmitting the SRS will be changed. For example, in order to continue to transmit the SRS, the terminal may switch from port #1 to port #2 to transmit the SRS. However, the terminal needs to wait for the RRC signaling or a BWP switching indication transmitted by the network device before adjusting the port for transmitting the SRS. On the one hand, the network device does not know that the port #1 has been occupied, so it is difficult to accurately indicate the terminal to switch to an unoccupied port to transmit the SRS. On the other hand, neither the RRC signaling nor BWP switching indication can achieve dynamic indication. For example, the RRC signaling is generally transmitted during establishment or disconnection of RRC connection, so it is impossible to dynamically change a configuration for transmitting the SRS by the terminal at any time, based on indications of changes in different scenarios and SIM card pathways, compromising the effectiveness and real-time performance of SRS transmission. Accordingly, the terminal needs to inform the network device of the expected related information for transmitting the SRS of the terminal, so that the network device can accordingly transmit configuration information to the terminal, to meet the requirement of the terminal successfully transmitting the SRS.

It should be noted that the reasons for the terminal needs to switch the port for transmitting the SRS include, but are not limited to, the aforementioned impact of using the SIM cards. For example, the terminal itself needs to adjust a capability of switching a port for transmitting sounding reference signal srs-TxPortSwitch, which will also lead to a need for switching the port.

According to the embodiments of the present disclosure, the network device can indicate, through the indication information, whether the terminal is allowed to report the expected related information for transmitting the SRS, so that the terminal can report the expected related information for transmitting the SRS when allowed, and does not report the expected related information for transmitting the SRS when not allowed, which helps meet the control of the network device on uplink transmission.

FIG. 5 is a schematic flowchart of another method for transmitting an indication according to an embodiment of the present disclosure. As shown in FIG. 5, the method further includes step S501.

In step S501, the expected related information for transmitting the SRS reported by the terminal is received, in a case where the indication information indicates that the terminal is allowed to report the expected related information for transmitting the SRS.

In one embodiment, in response to determining that the terminal is allowed to report the expected related information for transmitting the SRS, the terminal may report the expected related information for transmitting the SRS to the network device. By receiving the expected related information for transmitting the SRS of the terminal, the network device may timely and accurately determine the expected related information for transmitting the SRS of the terminal, and then may dynamically transmit the expected related information for transmitting the SRS of the terminal to the terminal as the configuration information, so that the terminal can successfully transmit the SRS.

For example, in the case where port #1 has been occupied by SIM card #2 in the aforementioned embodiment, the expected related information for transmitting the SRS of the terminal includes port #2, and in response to determining that the terminal is allowed to report the expected related information for transmitting the SRS, the expected port for transmitting the SRS includes port #2 may be reported. Accordingly, the network device can determine that the terminal expects to switch to port #2 to transmit the SRS, and then configuration information can be transmitted to the terminal, to configure the terminal to use port #2 to transmit the SRS. Accordingly, the terminal can switch to port #2 to transmit the SRS in time, thus ensuring that the SRS can be successfully transmitted.

In one embodiment, according to the expected related information for transmitting the SRS reported by the terminal, the network device may select one related information for transmitting the SRS from a plurality of related information for transmitting the SRS and indicate it to the terminal. The plurality of related information for transmitting the SRS may be indicated to the terminal in advance by the network device (for example, configured to the terminal through the RRC signaling), or may be appointed by a protocol.

In one embodiment, the configuration information transmitted to the terminal by the network device includes, but is not limited to, downlink control information (DCI), a media access control element (MAC CE), etc. Determining the DCI, the MAC CE and so on as the configuration information, the related information for transmitting the SRS may be dynamically adjusted, and the adjustment can be completed relatively in time compared with the adjustment of the related information for transmitting the SRS via the RRC signaling or the BWP switching indication.

In one embodiment, the expected related information for transmitting the SRS includes at least one of: a switching pattern of a port for transmitting the SRS; an impact of switching the port for transmitting the SRS on a communication state; a resource for transmitting the SRS; or a usage mode of the resource for transmitting the SRS.

In one embodiment, the switching pattern of the port for transmitting the SRS may refer to the quantity or the quantity combination of the receiving antenna (r) and the transmitting antenna (t) supported by the terminal, which may be determined by the terminal according to the current capability of srs-TxPortSwitch, so the expected switching pattern of the port for transmitting the SRS of the terminal may be represented as preferred-SupportedSRS-TxPortSwitch. For example, t1r2 represents that the terminal supports one transmitting antenna and two receiving antennas. For example, t1r4-t2r4 represents that the terminal supports one transmitting antenna and four receiving antennas, and also supports two transmitting antennas and four receiving antennas.

The quantity or the quantity combination of the receiving antenna (r) and the transmitting antenna (t) supported by the terminal include at least one of: t1r2, t1r4, t2r4, t2r2, t4r4, t1r4-t2r4, t1r1-t1r2, t1r1-t1r2-t1r4, t1r1-t1r2-t2r2-t2r4, t1r1-t2r2, t1r1-t2r2-t4r4, or t1r1-t1r2-t2r2-t1r4-t2r4.

It can be seen that the receiving antenna and the transmitting antenna supported by the terminal change with variations in the capability of the srs-TxPortSwitch of the terminal. Accordingly, after the capability of the srs-TxPortSwitch of the terminal has been changed, the switching pattern of the port for transmitting the SRS corresponding to the changed capability of the srs-TxPortSwitch may be reported to the network device. For example, if the unchanged capability of the srs-TxPortSwitch is t4r4 and the changed capability of the srs-TxPortSwitch is t2r2, then the expected switching pattern of the port for transmitting the SRS reported by the terminal may be t2r2. The network device may determine the port that the terminal can used for transmitting the SRS, according to the switching pattern of the port for transmitting the SRS, and then configure available ports for the terminal through the configuration information, so that the terminal can switch to the port in time to ensure successful transmitting of the SRS.

In one embodiment, the impact of switching the port for transmitting the SRS on the communication state includes at least one of: a downlink frequency affected by switching the port for transmitting the SRS, for example, it may be referred to txSwitchImpactToRx; an uplink frequency affected by switching the port for transmitting the SRS, for example, it may be referred to txSwitch WithAnotherBand; whether the downlink frequency is affected by switching the port for transmitting the SRS, for example, when the downlink frequency is affected by switching the port for transmitting the SRS, it may be referred to txSwitchImpactToRx, and when the downlink frequency is unaffected by switching the port for transmitting the SRS, it may be referred to txSwitchNoImpactToRx; and whether the uplink frequency is affected by switching the port for transmitting the SRS, for example, when the uplink frequency is affected by switching the port for transmitting the SRS, it is referred to txSwitchWithAnotherBand, and when the uplink frequency is unaffected by switching the port for transmitting the SRS, it is referred to txSwitchNoImpactWithAnotherBand.

When the terminal switches the port for transmitting the SRS, the communication state is affected or unaffected, and the impact on the communication state may be different based on different capabilities of the srs-TxPortSwitch supported by the terminal.

For example, in a case where the terminal supports t4r4, the downlink frequency is affected by switching the port for transmitting the SRS, a band specifically affected is band-x, and then the expected txSwitchImpactToRx reported by the terminal may be band-x. Accordingly, the network device can determine that band-x is affected, and then the frequency domain resource other than band-x may be configured for the terminal to receive downlink information, to ensure that the terminal can successfully receive the downlink information. When the capability of the srs-TxPortSwitch of the terminal is changed to t2r2, if switching port for transmitting the SRS does not affect the downlink frequency, then the terminal may report txSwitchNoImpactToRx.

For example, in a case where the terminal supports t4r4, the uplink frequency is affected by switching the port for transmitting the SRS, a band specifically affected is band-y, and then the expected txSwitchWithAnotherBand reported by the terminal may be band-y. Accordingly, the network device can determine that band-y is affected, and then the frequency domain resource other than band-y may be configured for the terminal to transmit the SRS, to ensure that the terminal can successfully transmit the SRS. When the capability of the srs-TxPortSwitch of the terminal is changed to t2r2, if switching the port for transmitting the SRS does not affect the uplink frequency, then the terminal may report txSwitchNoImpactWithAnotherBand.

For example, in a case where the terminal supports t4r4, by switching the port for transmitting the SRS, the affected downlink frequency is band-x1 and the affected uplink frequency is band-x2, and then the expected txSwitchImpactToRx reported by the terminal may be band-x1 and the expected txSwitchWithAnotherBand reported by the terminal may be band-x2. Accordingly, the network device can determine that downlink reception of band-x1 and uplink transmission of band-x2 are affected, so the frequency domain resource other than band-x1 may be configured for the terminal to receive downlink information, and the frequency domain resource other than band-x2 may be configured for the terminal to transmit the uplink SRS.

When the capability of srs-TxPortSwitch of the terminal is changed to t2r2, by switching the port for transmitting the SRS, the affected downlink frequency is changed to band-y1 and the affected uplink frequency is changed to band-y2, and then the expected txSwitchImpactToRx reported by the terminal may be band-y1 and the expected txSwitch WithAnotherBand reported by the terminal may be band-y2. Accordingly, the network device can determine that downlink reception of band-y1 and uplink transmission of band-y2 are affected, so the frequency domain resource other than band-y1 may be configured for the terminal to receive downlink information, and the frequency domain resource other than band-y2 may be configured for the terminal to transmit the uplink SRS.

In one embodiment, the resource for transmitting the SRS includes at least one of: the set SRS-ResourceSet of resources for transmitting the SRS; the resource SRS-Resource in the set; the port AntennaPortForSRS-ResourceSet corresponding to the set; the port AntennaPortForSRS corresponding to the resource; and the type SRS-ResourceType of the resource (the type includes, but not limited to, periodic, aperiodic, semi-persistent and etc.).

It should be noted that the related information for transmitting the SRS may include not only the resource for transmitting the SRS, but also a number of the resource for transmitting the SRS, such as a number of the set and a number of the port.

In one embodiment, the network device may configure a plurality of SRS-ResourceSets for the terminal in advance, and each SRS-ResourceSet may include at least one SRS-Resource (e.g., the time domain resource and/or the frequency domain resource). Then, when the terminal determines that the terminal is allowed to report an expected SRS-ResourceSet, the expected SRS-ResourceSet may be selected from the plurality of SRS-ResourceSets according to the terminal's own need and reported to the network device, the network device may transmit configuration information to the terminal according to the expected SRS-ResourceSet of the terminal, and the terminal may transmit the SRS according to the resource in the SRS-ResourceSet configured by the configuration information.

In one embodiment, the network device may configure a plurality of SRS-Resources in each SRS-ResourceSet for the terminal in advance. Then, when the terminal determines that it is allowed to report an expected SRS-Resource, the expected SRS-Resource may be selected from the plurality of SRS-Resources according to the terminal's own need and reported to the network device, the network device may transmit configuration information to the terminal according to the expected SRS-Resource of the terminal, and the terminal may transmit the SRS according to the SRS-Resource configured by the configuration information.

In one embodiment, the network device may configure a plurality of AntennaPortForSRS-ResourceSets for the terminal in advance. Then, when the terminal determines that it is allowed to report an expected AntennaPortForSRS-ResourceSet, the expected AntennaPortForSRS-ResourceSet may be selected from the plurality of AntennaPortForSRS-ResourceSets according to the terminal's own need and reported to the network device, the network device may transmit configuration information to the terminal according to the expected AntennaPortForSRS-ResourceSet of the terminal, and the terminal may transmit the SRS according to the AntennaPortForSRS-ResourceSet configured by the configuration information.

In one embodiment, the network device may configure a plurality of AntennaPortForSRSs for the terminal in advance. Then, when the terminal determines that it is allowed to report a expected AntennaPortForSRS, the expected AntennaPortForSRS may be selected from the plurality of AntennaPortForSRSs according to the terminal's own need and reported to the network device, the network device may transmit configuration information to the terminal according to the expected AntennaPortForSRS of the terminal, and the terminal may transmit the SRS according to the AntennaPortForSRS configured by the configuration information.

In one embodiment, the usage mode of the resource for transmitting the SRS includes at least one of: antenna switching; beam management; codebook; or non-codebook.

In one embodiment, when the terminal determines that it is allowed to report an expected usage mode of the resources for transmitting the SRS, the expected usage mode may be selected from the aforementioned usage modes according to the terminal's own need and reported to the network device, the network device may transmit configuration information to the terminal according to the expected usage mode of the terminal, and the terminal may transmit the SRS according to the usage mode configured by the configuration information.

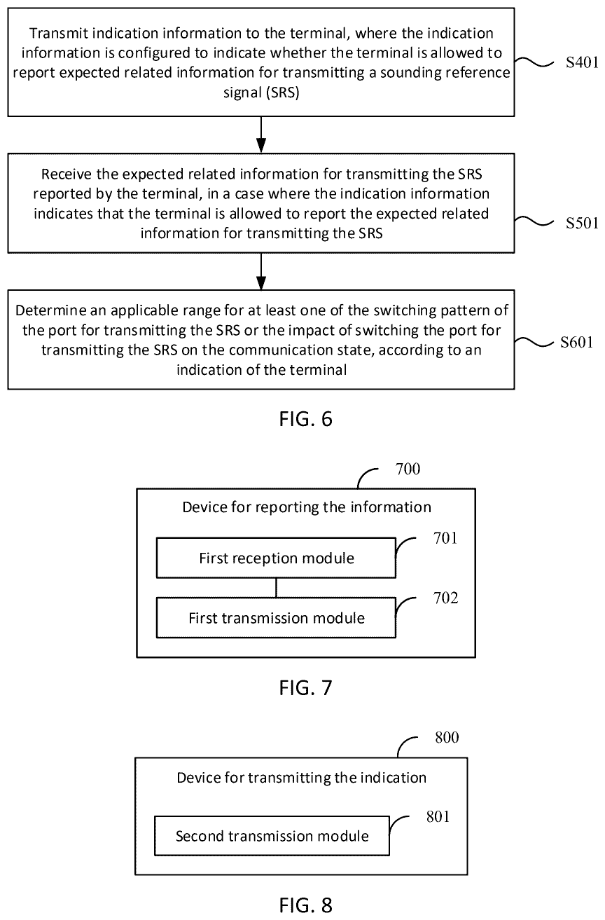

FIG. 6 is a schematic flowchart of yet another method for transmitting an indication according to an embodiment of the present disclosure. As shown in FIG. 6, the method further includes step S601.

In step S601, an applicable range for at least one of the switching pattern of the port for transmitting the SRS or the impact of switching the port for transmitting the SRS on the communication state is determined, according to an indication of the terminal.

The applicable range includes at least one of: a radio access technology (RAT), including, but not limited to, 4G, 5G, 6G, etc.; a band; a bandwidth part (BWP); a cell; and the terminal, e.g., user equipment (UE).

In one embodiment, in a case where the terminal reports the expected switching pattern of the for transmitting the SRS to the network device, the terminal can also indicate to the network device the applicable range for the switching pattern of the port for transmitting the SRS. Similarly, in a case where the terminal reports the expected impact of switching the port for transmitting the SRS on the communication state to the network device, the terminal can also indicate to the network device the applicable range of the impact of switching the port for transmitting the SRS on the communication state.

Taking the terminal reporting the expected switching pattern of the port for transmitting the SRS to the network device as an example, if the indicated applicable range is the terminal (e.g., per UE), then the network device may transmit configuration information to the indicated terminal according to the expected switching pattern of the port for transmitting the SRS; if the indicated applicable range is the cell (e.g., per Cell), then the network device may transmit configuration information to the terminal in the indicated cell according to the expected switching pattern of the port for transmitting the SRS; if the indicated applicable range is the bandwidth part (e.g., per BWP), then the network device may transmit configuration information to the terminal using the indicated bandwidth part according to the expected switching pattern of the port for transmitting the SRS; if the indicated applicable range is the band (e.g., per band), then the network device may transmit configuration information to the terminal using the indicated band according to the expected switching pattern of the port for transmitting the SRS; and if the indicated applicable range is the wireless access technology (e.g., per RAT), then the network device may transmit configuration information to the terminal using the indicated wireless access technology according to the expected switching pattern of the port for transmitting the SRS.

The band in the applicable range may be a single band, a band combination (e.g., per Band Combination), or a single band in the band combination (e.g., per Band per Band Combination).

Corresponding to the aforementioned embodiments of the method for reporting the information and the method for transmitting the indication, the present disclosure further provides embodiments of a device for reporting the information and a device for transmitting the indication.

FIG. 7 is a schematic block diagram of a device 700 for reporting the information according to an embodiment of the present disclosure. The device for reporting the information illustrated in the present embodiment may be the terminal or a device composed of modules in the terminal, and the terminal includes, but is not limited to, the communication device such as the mobile phone, the tablet computer, the wearable device, the sensor or the Internet of Things device. The terminal may communicate with the network device, which includes, but not limited to, the network device in 4G, 5G, 6G or other communication systems, such as the base station or the core network.

As shown in FIG. 7, the device 700 for reporting the information includes: a first reception module 701, configured to receive indication information transmitted by the network device; and a first transmission module 702, configured to report expected related information for transmitting the SRS to the network device, in response to determining that the network device allows the terminal to report the expected related information for transmitting the SRS according to the indication information.

In one embodiment, the expected related information for transmitting the SRS includes at least one of: a switching pattern of a port for transmitting the SRS; an impact of switching the port for transmitting the SRS on a communication state; a resource for transmitting the SRS; or a usage mode of the resource for transmitting the SRS.

In one embodiment, the impact of switching the port for transmitting the SRS on the communication state includes at least one of: a downlink frequency affected by switching the port for transmitting the SRS; an uplink frequency affected by switching the port for transmitting the SRS; whether the downlink frequency is affected by switching the port for transmitting the SRS; or whether the uplink frequency is affected by switching the port for transmitting the SRS.

In one embodiment, the resource for transmitting the SRS includes at least one of: a set of resources for transmitting the SRS; a resource in the set; a port corresponding to the set; a port corresponding to the resource; or a type of the resource.

In one embodiment, the usage mode of the resource for transmitting the SRS includes at least one of: antenna switching; beam management; codebook; or non-codebook.

In one embodiment, the first transmission module 702 is further configured to indicate, to the network device, an applicable range for at least one of the switching pattern of the port for transmitting the SRS or the impact of switching the port for transmitting the SRS on the communication state.

In one embodiment, the applicable range includes at least one of: a radio access technology; a band; a bandwidth part; a cell; and the terminal.

In one embodiment, the first transmission module 702 is configured to report the expected related information for transmitting the SRS to the network device, in a case where a wireless communication state meets a triggering condition.

In one embodiment, meeting the triggering condition includes at least one of: an antenna of the terminal is occupied; or the expected related information for transmitting the SRS of the terminal is changed.

FIG. 8 is a schematic block diagram of a device 800 for transmitting the indication according to an embodiment of the present disclosure. The device 800 for transmitting the indication illustrated in the present embodiment may be the network device or a device composed of modules in the network device, the network device may communicate with the terminal, and the terminal includes, but is not limited to, the communication device such as the mobile phone, the tablet computer, the wearable device, the sensor or the Internet of Things device. The network device includes, but not limited to, the network device in 4G, 5G, 6G or other communication systems, such as the base station or the core network.

As shown in FIG. 8, the device 800 for transmitting the indication includes a second transmission module 801, configured to transmit indication information to a terminal, where the indication information is configured to indicate whether the terminal is allowed to report expected related information for transmitting a sounding reference signal (SRS).

In one embodiment, the device 800 for transmitting the indication further includes: a second receiving module (not shown), configured to receive the expected related information for transmitting the SRS reported by the terminal, in a case where the indication information indicates that the terminal is allowed to report the expected related information for transmitting the SRS.

In one embodiment, the expected related information for transmitting the SRS includes at least one of: a switching pattern of a port for transmitting the SRS; an impact of switching the port for transmitting the SRS on a communication state; a resource for transmitting the SRS; or a usage mode of the resource for transmitting the SRS.

In one embodiment, the impact of switching the port for transmitting the SRS on the communication state includes at least one of: a downlink frequency affected by switching the port for transmitting the SRS; an uplink frequency affected by switching the port for transmitting the SRS; whether the downlink frequency is affected by switching the port for transmitting the SRS; or whether the uplink frequency is affected by switching the port for transmitting the SRS.

In one embodiment, the resource for transmitting the SRS include at least one of: a set of resources for transmitting the SRS; a resource in the set; a port corresponding to the set; a port corresponding to the resource; and a type of the resource.

In one embodiment, the usage mode of the resource for transmitting the SRS includes at least one of: antenna switching; beam management; codebook; or non-codebook.

In one embodiment, the device 800 for transmitting the indication further includes: a processing module (not shown), configured to determine, according to an indication of the terminal, an applicable range for at least one of the switching pattern of the port for transmitting the SRS or the impact of switching the port for transmitting the SRS on the communication state.

In one embodiment, the applicable range includes at least one of: a radio access technology; a band; a bandwidth part; a cell; or the terminal.

With regard to the device in the aforementioned embodiments, the specific way in which each module performs operations has been described in detail in the embodiments of the related method, and will not be described in detail here.

Because the device embodiments basically correspond to the method embodiments, for related contents, refer to part of the description of the method embodiments. The device embodiments described above are merely schematic, where the modules described as separated components may or may not be physically separated, and the components displayed as modules may or may not be physical modules, that is, they may be located at one place or distributed to multiple network modules. Some or all of the modules may be selected according to actual needs to achieve the objective of the solution of the present embodiment. Those of ordinary skill in the art can understand and implement it without making creative efforts.

An embodiment of the present disclosure further provides a communication device, which includes: a processor; and a memory that stores a computer program; where, when the computer program, when executed by the processor, implements the method for reporting the information according to any of the aforementioned embodiments.

An embodiment of the present disclosure further provides a communication device, which includes: a processor; and a memory that stores a computer program; where, when the computer program, when executed by the processor, implements the method for transmitting the indication according to any of the aforementioned embodiments.

An embodiment of the present disclosure further provides a non-transitory computer-readable storage medium, which storing a computer program, where the computer program, when executed by a processor, implements the steps in the method for reporting the information according to any of the aforementioned embodiments.

An embodiment of the present disclosure further provides a non-transitory computer-readable storage medium, which storing a computer program, where the computer program, when executed by a processor, implements the steps in the method for transmitting the indication according to any of the aforementioned embodiments.

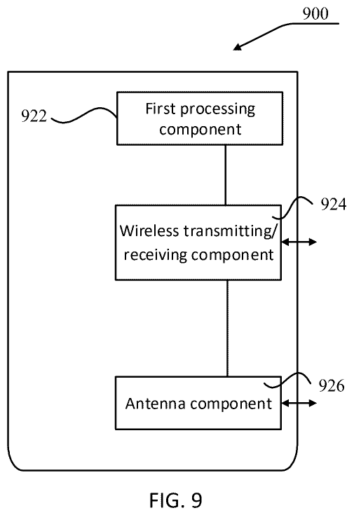

As shown in FIG. 9, FIG. 9 is a schematic block diagram of a device 900 for transmitting the indication according to an embodiment of the present disclosure. The device 900 may be provided as a base station. Referring to FIG. 9, the device 900 includes a first processing component 922, a wireless transmitting/receiving component 924, an antenna component 926, and a signal processing part specific to a wireless interface, where the first processing component 922 may further include one or more processors. One of the processors in the first processing component 922 may be configured to implement the method for transmitting the indication according to any of the aforementioned embodiments.

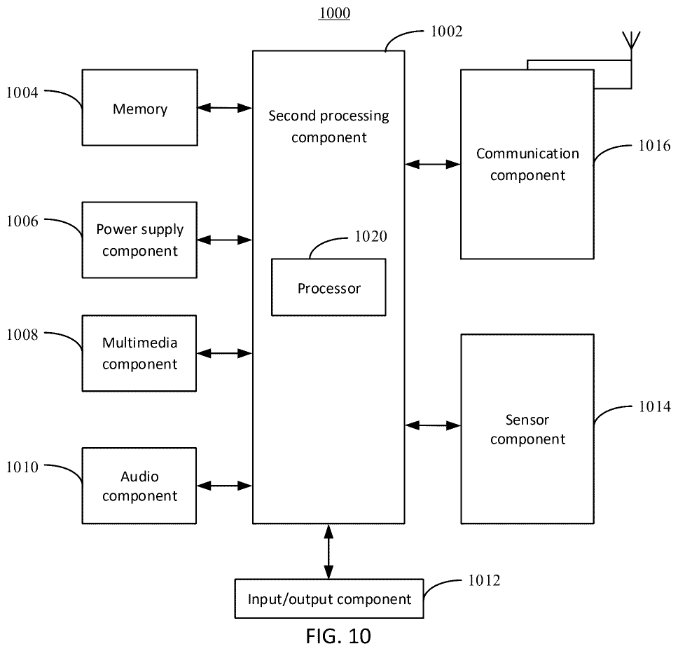

FIG. 10 is a schematic block diagram of a device 1000 for information reporting according to an embodiment of the present disclosure. For example, the device 1000 may be a mobile phone, a computer, a digital broadcasting terminal, a messaging device, a game console, a tablet device, a medical device, a fitness device, a personal digital assistant, etc.

Referring to FIG. 10, the device 1000 may include one or more of the following components: a second processing component 1002, a memory 1004, a power supply component 1006, a multimedia component 1008, an audio component 1010, an input/output (I/O) interface 1012, a sensor component 1014, or a communication component 1016.

The second processing component 1002 generally controls the overall operation of the device 1000, such as operations associated with display, telephone calls, data communication, camera operation, or recording operation. The second processing component 1002 may include one or more processors 1020 to execute instructions to execute all or part of the steps of the aforementioned information reporting method. In addition, the second processing component 1002 may include one or more modules to facilitate an interaction between the second processing component 1002 and the other components. For example, the second processing component 1002 may include a multimedia module to facilitate an interaction between the multimedia component 1008 and the second processing component 1002.

The memory 1004 is configured to store various types of data to support operations at the device 1000. Examples of these data include instructions for any application or method operating at the device 1000, contact data, phonebook data, messages, pictures, videos, etc. The memory 1004 may be implemented by any type of volatile or nonvolatile storage device or a combination of these storage devices, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or a compact disk.

The power supply component 1006 supplies power to the various components of the device 1000. The power component 1006 may include a power management system, one or more power supplies, and other components associated with generating, managing and distributing power for the device 1000.

The multimedia component 1008 includes a screen providing an output interface between the device 1000 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, sliding, and gestures on the touch panel. The touch sensor may not only sense a boundary of a touch or sliding action, but also detect a duration and a pressure related to the touch or sliding operation. In some embodiments, the multimedia component 1008 includes a front camera and/or a rear camera. When the device 1000 is in an operation mode, such as a shooting mode or a video mode, the front camera and/or the rear camera can receive external multimedia data. Each of the front camera and the rear camera may be a fixed optical lens system or has a focal length and optical zoom capability.

The audio component 1010 is configured to output and/or input audio signals. For example, the audio component 1010 includes a microphone (MIC), which is configured to receive external audio signals when the device 1000 is in operation modes, such as a call mode, a recording mode and a voice recognition mode. The received audio signals may be further stored in the memory 1004 or transmitted via the communication component 1016. In some embodiments, the audio component 1010 further includes a speaker for outputting audio signals.

The I/O interface 1012 provides an interface between the second processing component 1002 and peripheral interface modules, and the peripheral interface modules may be a keyboard, a click wheel, buttons, etc. These buttons may include, but are not limited to, a home button, volume buttons, a start button, and a lock button.

The sensor component 1014 includes one or more sensors configured to provide various aspects of status estimation for the device 1000. For example, the sensor component 1014 may detect an on/off state of the device 1000 and relative positioning of components (such as a display and a keypad of the device 1000); and the sensor component 1014 may also detect a position change of the device 1000 or one component of the device 1000, whether the user contacts with the device 1000, an orientation or acceleration/deceleration of the device 1000, and a temperature change of the device 1000. The sensor component 1014 may include a proximity sensor, which is configured to detect the presence of a nearby object without any physical contact. The sensor component 1014 may further include an optical sensor (such as a CMOS or CCD image sensor) for use in imaging applications. In some embodiments, the sensor component 1014 may further include an acceleration sensor, a gyro sensor, a magnetic sensor, a pressure sensor, or a temperature sensor.

The communication component 1016 is configured to facilitate wired or wireless communication between the device 1000 and another devices. The device 1000 may access a wireless network based on communication standards, such as WiFi, 2G, 3G, 4G LTE, 5G NR or their combination. In an example, the communication component 1016 receives broadcast signals or broadcast related information from an external broadcast management system via a broadcast channel. In an example, the communication component 1016 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology and other technologies.

In an example, the device 1000 may be implemented by one or more application-specific integrated circuits (ASIC), a digital signal processor (DSP), a digital signal processing device (DSPD), a programmable logic device (PLD), a field programmable gate array (FPGA), a controller, a microcontroller, a microprocessor, or other electronic components, and is configured to perform the aforementioned information reporting method.

In an example, there is also provided a non-transitory computer-readable storage medium including instructions, such as the memory 1004 including instructions, where the aforementioned instructions may be executed by the processor 1020 of the device 1000 to execute the aforementioned information reporting method. For example, the non-transitory computer-readable storage medium may be a ROM, a random access memory (RAM), a CD-ROM, a magnetic tape, a floppy disk, or an optical data storage device.

Those skilled in the art will easily think of other embodiments of the present disclosure after considering the specification and practicing the disclosure disclosed herein. The present disclosure is intended to cover any variation, use or adaptation of the present disclosure, which follows the general principle of the present disclosure and includes the common knowledge or conventional technical means in the art which the present disclosure has not disclosed. The specification and the embodiments are to be regarded as exemplary only, and the true scope and spirit of the present disclosure is indicated by the following claims.

It should be understood that the present disclosure is not limited to the precise structure described above and shown in the accompanying drawings, and various modifications and changes can be made without departing from its scope. The scope of the present disclosure is limited only by the appended claims.

It should be noted that in this document, relational terms, such as first and second, are merely used to distinguish one entity or operation from another entity or operation, and do not necessarily require or imply that there is any such actual relationship or order between these entities or operations. The term “comprise”, “include” or any other variant thereof herein is intended to cover non-exclusive inclusion, so that a process, method, article or device including a series of elements includes not only those elements but also other elements not explicitly listed or elements inherent to such process, method, article or device. Without more restrictions, the elements defined by the sentence “include a . . . ” do not exclude the presence of other identical elements in the process, method, article or device including the elements.

The methods and devices provided by the embodiments of the present disclosure have been introduced in detail above, the specific examples are applied herein to elaborate the principle and embodiments of the present disclosure, and the illustration of the above embodiments are merely intended to offer help in understanding the method of the present disclosure and its core idea; moreover, for those skilled in the art, both the specific embodiments and the scope of application can be changed, and to sum up, the contents of the description should not be understood as a limitation on the present disclosure.

1. A method for reporting information, performed by a terminal, comprising:
receiving indication information transmitted by a network device; and
reporting expected related information for transmitting a sounding reference signal (SRS) to the network device, in response to determining that the network device allows the terminal to report the expected related information for transmitting the SRS according to the indication information.

2. The method according to claim 1, wherein the expected related information for transmitting the SRS comprises at least one of:
a switching pattern of a port for transmitting the SRS;
an impact of switching the port for transmitting the SRS on a communication state;
a resource for transmitting the SRS; or
a usage mode of the resource for transmitting the SRS.

3. The method according to claim 2, wherein the impact of switching the port for transmitting the SRS on the communication state comprises at least one of:
a downlink frequency affected by switching the port for transmitting the SRS;
an uplink frequency affected by switching the port for transmitting the SRS;
whether the downlink frequency is affected by switching the port for transmitting the SRS; or
whether the uplink frequency is affected by switching the port for transmitting the SRS.

4. The method according to claim 2, wherein the resource for transmitting the SRS comprises at least one of:
a set of resources for transmitting the SRS;
a resource in the set;
a port corresponding to the set;
a port corresponding to the resource; or
a type of the resource.

5. The method according to claim 2, wherein the usage mode of the resource for transmitting the SRS comprises at least one of:
antenna switching;
beam management;
codebook; or
non-codebook.

6. The method according to claim 2, further comprising:
indicating, to the network device, an applicable range for at least one of the switching pattern of the port for transmitting the SRS or the impact of switching the port for transmitting the SRS on the communication state.

7. The method according to claim 6, wherein the applicable range comprises at least one of:
a radio access technology;
a band;
a bandwidth part;
a cell; or
the terminal.

8. The method according to claim 1, wherein reporting the expected related information for transmitting the SRS to the network device comprises:
reporting the expected related information for transmitting the SRS to the network device, in a case where a wireless communication state meets a triggering condition.

9. The method according to claim 8, wherein meeting the triggering condition comprises at least one of:
an antenna of the terminal is occupied; or
the expected related information for transmitting the SRS of the terminal is changed.

10. A method for transmitting an indication, performed by a network device, comprising:
transmitting indication information to a terminal, wherein the indication information is configured to indicate whether the terminal is allowed to report expected related information for transmitting a sounding reference signal (SRS).

11. The method according to claim 10, further comprising:
receiving the expected related information for transmitting the SRS reported by the terminal, in a case where the indication information indicates that the terminal is allowed to report the expected related information for transmitting the SRS.

12. The method according to claim 10, wherein the expected related information for transmitting the SRS comprises at least one of:
a switching pattern of a port for transmitting the SRS;
an impact of switching the port for transmitting the SRS on a communication state;
a resource for transmitting the SRS; or
a usage mode of the resource for transmitting the SRS.

13. The method according to claim 12, wherein the impact of switching the port for transmitting the SRS on the communication state comprises at least one of:
a downlink frequency affected by switching the port for transmitting the SRS;
an uplink frequency affected by switching the port for transmitting the SRS;
whether the downlink frequency is affected by switching the port for transmitting the SRS; or
whether the uplink frequency is affected by switching the port for transmitting the SRS.

14. The method according to claim 12, wherein the resource for transmitting the SRS comprises at least one of:
a set of resources for transmitting the SRS;
a resource in the set;
a port corresponding to the set;
a port corresponding to the resource; or
a type of the resource.

15. The method according to claim 12, wherein the usage mode of the resource for transmitting the SRS comprises at least one of:
antenna switching;
beam management;
codebook; or
non-codebook.

16. The method according to claim 12, further comprising:
determining, according to an indication of the terminal, an applicable range for at least one of the switching pattern of the port for transmitting the SRS or the impact of switching the port for transmitting the SRS on the communication state.

17. The method according to claim 16, wherein the applicable range comprises at least one of:
a radio access technology;
a band;
a bandwidth part;
a cell; or
the terminal.

18.-19. (canceled)

20. A communication device, comprising:
a processor; and
a memory that stores a computer program, wherein the computer program, when executed by the processor, causes the processor to:
receive indication information transmitted by a network device, and
report expected related information for transmitting a sounding reference signal (SRS) to the network device, in response to determining that the network device allows the terminal to report the expected related information for transmitting the SRS according to the indication information.

21. A communication device, comprising:
a processor; and
a memory that stores a computer program, wherein the computer program, when executed by the processor, implements the method for transmitting the indication according to claim 10.

22. A non-transitory computer-readable storage medium storing a computer program, wherein the computer program, when executed by a processor, implements the method for reporting the information according to claim 1.

23. (canceled)
